(19) United States
(12) Patent Application Publication
(10) Pub. No.: US 2026/0064440 A1
(43) Pub. Date: Mar. 5, 2026

(54) Computing System And Method For Generating Personalized Versions Of GUI Views

(71) Applicant: Procore Technologies, Inc., Carpinteria, CA (US)

(72) Inventors: Aaron Kettl, Austin, TX (US); Matt Man, Ontario (CA); Nicholas Tilden, Austin, TX (US); Tim Doherty, Goleta, CA (US); Michael Sinai, Los Angeles, CA (US); Robert Farr, Lathrop, MO (US); Alvaro Soto, Austin, TX (US); Chris Cantu, Austin, TX (US)

(21) Appl. No.: 18/819,458

(22) Filed: Aug. 29, 2024

(51) Int. Cl. G06F 9/451; G06Q 50/08

(52) U.S. Cl. CPC G06F 9/451; G06Q 50/08

(57) ABSTRACT

An example computing platform is configured to: (i) receive, from a client device associated with a given user, a request to access a given GUI view of a construction management software application; (ii) obtain a set of baseline GUI data for the given GUI view; (iii) obtain a set of feature data for use in personalizing the given GUI view for the given user, (iv) obtain a set of payload data including content to be made available to the given user via the given GUI view; (v) generate a personalized version of the given GUI view based on the set of baseline GUI data, the set of feature data, and the set of payload data; and (vi) cause the personalized version of the given GUI view to be presented to the given user.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### OVERVIEW

Disclosed herein is new software technology for personalizing GUI views that are presented to a given user of a construction management software application. At a high level, the disclosed software technology may involve (i) determining that a given user has requested access to a given GUI view of a construction management software application, (ii) obtaining a set of baseline GUI data for the given GUI view, which may include data indicating a general purpose of the given GUI view, data indicating a type of content to be presented via the given GUI view, data indicating user actions that are to be supported by the given GUI view, and perhaps also data indicating a baseline layout of the given GUI view (e.g., in terms of the types of UI elements and the layout of such UI elements), (iii) obtaining a set of feature data for use in personalizing the given GUI view for the given user, (iv) obtaining a set of payload data including content to be made available to the given user via the given GUI view, (v) based on the set of baseline GUI data for the given GUI view, the set of feature data, and the set of payload data, generating a personalized version of the given GUI view (which may differ from a “default” version of the given GUI view that would otherwise be presented if no personalization is done), and (vi) causing the personalized version of the given GUI view to be presented to the given user (e.g., by transmitting the set of configuration data to a client device through which the given user is accessing the construction management software application along with an instruction to render the personalized version of the given GUI view).

In one aspect, the disclosed technology may take the form of a method to be carried out by a computing system that involves (i) receiving, from a client device associated with a given user, a request to access a given Graphical User Interface (GUI) view of a construction management software application; (ii) obtaining a set of baseline GUI data for the given GUI view; (iii) obtaining a set of feature data for use in personalizing the given GUI view for the given user, wherein the set of feature data comprises values for at least two of (a) a user-level feature that provides information about the given user, (b) a party-level feature that provides information about a party with which the given user is associated, (c) a project-level feature that provides information about a construction project with which the given GUI view is associated, or (d) a similar-user feature that provides information about one or more other users determined to be similar to the given user; (iv) obtaining a set of payload data including content to be made available to the given user via the given GUI view; (v) generating a personalized version of the given GUI view based on the set of baseline GUI data, the set of feature data, and the set of payload data; and (vi) causing the personalized version of the given GUI view to be presented to the given user.

In some examples, the set of baseline GUI data comprises at least one of: (i) data that indicates a purpose of the given GUI view; (ii) data that indicates a type of content to be presented via the given GUI view; (iii) data that indicates user actions that are to be supported by the given GUI view; or (iv) data that indicates a baseline layout of the given GUI view.

Further, in some examples, the set of feature data comprises values for each of (i) one or more user-level features that provide information about the given user, (ii) one or more party-level features that provide information about the party with which the given user is associated, (iii) one or more project-level features that provides information about a construction project with which the given GUI view is associated, and (iv) one or more similar-user features that provide information about one or more other users determined to be similar to the given user.

Still further, in some examples, generating the personalized version of the given GUI view based on the set of baseline GUI data, the set of feature data, and the set of payload data comprises (i) using the set of baseline GUI data, the set of feature data, and the set of payload data to produce an input dataset for an Artificial Intelligence (AI) model architecture; and (ii) inputting the input dataset into the AI model architecture and thereby causing the AI model architecture to generate the personalized version of the given GUI view.

Still further, in some examples, the AI model architecture comprises a generative AI model, and the input dataset for the AI model architecture comprises a prompt for the generative AI model that includes (i) a request to generate the personalized version of the given GUI view and (ii) context for the request.

Still further, in some examples, the AI model architecture further comprises a reward model that is configured to output a reward value for the personalized version of the given GUI view based on user interaction with the personalized version of the given GUI view, and the generative AI model is configured to refine a policy for generating personalized versions of GUI views based on the reward value.

Still further, in some examples, the personalized version of the given GUI view is defined by a set of configuration data output by the AI model architecture in response to the inputting of the input dataset.

Still further, in some examples, causing the computing platform to cause the personalized version of the given GUI view to be presented to the given user comprises transmitting a communication to the client device that instructs the client device to render the personalized version of the given GUI view.

Still further, in some examples, the personalized version of the given GUI view comprises at least one of (i) a personalized set of GUI elements included within the given GUI view, (ii) a personalized set of content presented via the given GUI view, or (iii) a personalized layout of the given GUI view.

Still further, in some examples, generating the personalized version of the given GUI view based on the set of baseline GUI data, the set of feature data, and the set of payload data comprises extracting one or more semantic meanings from textual content included in the payload data.

In yet another aspect, disclosed herein is a computing platform that includes at least one communication interface, at least one processor, at least one non-transitory computer-readable medium, and program instructions stored on the at least one non-transitory computer-readable medium that, when executed by the at least one processor, cause the computing platform to carry out the functions disclosed herein, including (but not limited to) any of the functions of the foregoing methods.

In yet another aspect, disclosed herein is a non-transitory computer-readable medium provisioned with program instructions that, when executed by at least one processor, cause a computing platform to carry out the functions disclosed herein, including (but not limited to) any of the functions of the foregoing methods.

One of ordinary skill in the art will appreciate these as well as numerous other aspects in reading the following disclosure.

### BRIEF DESCRIPTION OF THE DRAWINGS

FIG. 1 depicts an example network environment in which a construction management software application may be implemented, according to the present disclosure.

FIG. 2A depicts an illustrative example of a project-overview GUI view that provides overview-level information about a construction project in which a party is involved, according to the present disclosure.

FIG. 2B depicts an illustrative example of a personalized version of the GUI view of FIG. 2A that is produced by the disclosed software technology, according to the present disclosure.

FIG. 3 depicts example functionality of the disclosed software technology in the form of a flow diagram, according to the present disclosure.

FIG. 4 depicts an illustrative example of an AI model architecture that may be utilized to generate a personalized version of a given GUI view for a given user, according to the present disclosure.

FIG. 5 is a simplified block diagram that illustrates some structural components that may be included in an example computing platform, according to the present disclosure.

FIG. 6 is a simplified block diagram that illustrates some structural components that may be included in an example client device, according to the present disclosure.

### DETAILED DESCRIPTION

The following disclosure refers to the accompanying figures and several examples. A person of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

Construction management today is often performed through the use of software applications, such as the software application provided by Procore Technologies, Inc.® (“Procore,” which is the applicant of the present disclosure). These software applications generally provide users the ability to create, store, view, and/or interact with various types of data related to a construction project, such as specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project, etc.), directories, invoices, timesheets, meeting minutes, sensor data, and daily logs (e.g., which record information about each day work is done at a work site of the construction project), among many other examples of project data that may be stored for a construction project.

In practice, these construction management software applications may take various forms. As one possible implementation, a construction management software application may include both front-end client software running on client devices that are accessible to individuals associated with construction projects (e.g., contractors, project managers, architects, engineers, designers, etc.) and back-end software running on a back-end platform (sometimes referred to as a “cloud” platform) that interacts with and/or drives the front-end software, and which may be operated (either directly or indirectly) by the provider of the front-end client software. This form of a software application may be referred to as a client-server application or a software-as-a-service (SaaS) application, among other possibilities. As another possible implementation, a construction management software application may include front-end client software that runs on client devices without interaction with a back-end platform. These software applications may take other forms as well.

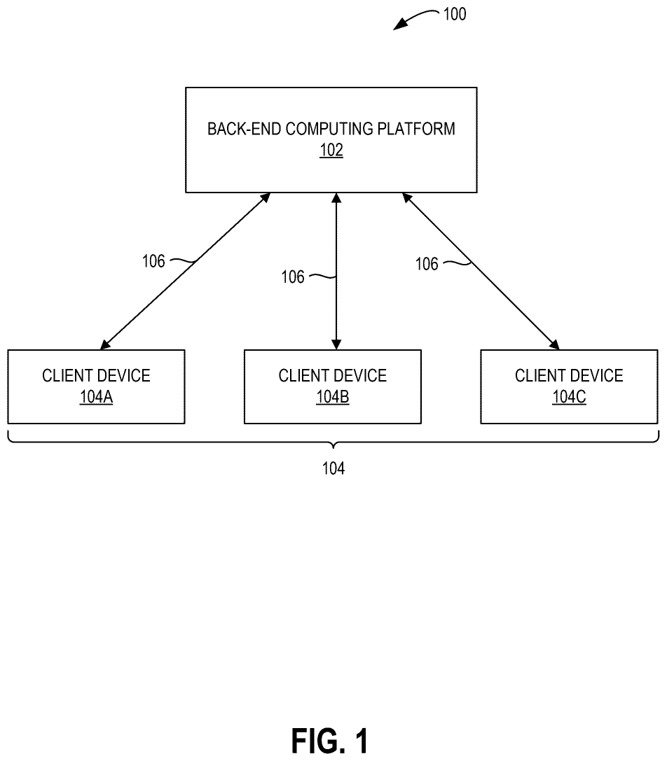

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which include the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of the back-end computing platform 102 may collectively comprise some set of physical computing resources (e.g., one or more processors, data storage systems, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106. In this respect, each of the communication paths 106 between the back-end computing platform 102 and one of the client devices 104 may generally comprise one or more communication networks and/or communications links, which may take any of various forms. For instance, each of the respective communication paths 106 with the back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each of the respective communication paths 106 with the back-end computing platform 102 may be wireless, wired, or some combination thereof, and may carry data according to any of various different communication protocols. Further yet, communications over each of the respective communication paths 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). Many other environments are also possible.

Although not shown in FIG. 1, the back-end computing platform 102 may also be configured to receive data, such as data related to a construction project, from one or more external data sources, such as an external database and/or another back-end computing platform or platforms. Such data source—and the data output by such data sources—may take various forms.

It should be understood that the network environment 100 depicted in FIG. 1 is one example of a network environment in which a construction management software application may be implemented. Numerous other arrangements are possible and contemplated herein. For instance, other network configurations may include additional components not pictured and/or more or fewer of the pictured components.

In line with the discussion above, construction management software applications may enable users to manage construction projects electronically, which may involve software features for creating, storing, viewing, and/or interacting with various types of data that may be stored as objects of various forms (e.g., specifications, drawings, BIM files, RFIs, punch lists, directories, invoices, timesheets, meeting minutes, daily logs, etc.). Further, in at least some implementations, the software features for creating, storing, viewing, and/or interacting with the various types of data objects may optionally be arranged into different software “tools” that each correspond to a different type (or category) of data object. For instance, a construction management software application may include an “RFIs” tool for creating, storing, viewing, and/or interacting with RFI data objects, a “Daily Log” tool for creating, storing, viewing, and/or interacting with Daily Log data objects, and so on. However, in other implementations, the software features for creating, storing, viewing, and/or interacting with the various types of data objects may be arranged in other manners that are not based on software tools paradigm.

In operation, existing construction management software applications may enable a representative of a given party to (i) create an account with a construction management software application and (ii) add a set of individuals associated with the given party as users on the given party's account. After the given party's account is created and a set of users have been added, the construction management software application may thereafter enable the representative of the given party (or some other representative that has been added to the account as a user having the requisite permissions) to (i) create a respective project workspace for each of one or more construction projects that involve the given party and (ii) for each such construction project, designate a respective subset of the given party's users that are allowed to access data associated with the respective project workspace. In this respect, the given party may be considered to be the “owner”of the project workspace(s) and the data contained therein.

Turning to the interface through which users may manage construction projects, a construction management software application may include a graphical user interface (GUI) through which users may access software features for accomplishing the various tasks involved in managing construction projects. Given the wide variety of data that users may access and the wide variety of tasks that users may perform via a given construction management software application, the GUI may involve a collection of GUI views (e.g., pages) that serve different purposes within the given application. A given GUI view may comprise a corresponding set of GUI elements that are arranged and/or configured in a particular way. These GUI elements may take various forms.

For instance, as one possibility, a GUI element may be an input-control element that is configured to receive user input. A few illustrative examples of input-control elements include a text field (e.g., a single-line text field or a multi-line text field), a button (e.g., a push button that triggers an action when clicked, a toggle button that allows a user to switch between two or more alternatives, a radio button that allows a user to select just a single option from a list of options, etc.), a check box (e.g., that allow a user to select one or more options from a list of options), a slider (e.g., that allows a user to adjust a value within a range by moving a handle across a track), an input stepper (e.g., a combination of a text box for displaying a value, a first button that increases the displayed value in response to being clicked, and a second button that decreases the displayed value in response to being clicked), a list (e.g., a dropdown list that displays options and allows a user to select one by clicking on the desired option), and an uploader (e.g., a box into which a user can drag and drop a file to be uploaded, a combination of a button that triggers a display of a folder including candidate files to be uploaded and a text box that displays the name of a file selected for upload), among other possible examples.

As another possibility, a GUI element may be a navigational element that allows a given user to navigate to different views (e.g., pages) within a GUI. A few illustrative examples of navigational elements include a breadcrumb (e.g., a clickable trail of preceding pages, such as a hierarchy of pages in hierarchical levels above a current page or a list of links a given user followed to arrive at the current page), a button (e.g., a back button that allows a given user to revisit a penultimate page that was viewed immediately prior to a given page, a forward button that allows a given user to return to return from the penultimate page to the given page, etc.), a link ( e.g., comprising a uniform resource locator (URL)), an icon (e.g., an icon that triggers display of a particular view in response to being clicked, such as a folder icon that triggers display of a window showing the contents of a corresponding folder in response to being clicked), an image carousel (e.g., that allows a given user to scroll through a set of thumbnail images of different views and select a given view to display by clicking on the thumbnail image of the given view), a tag, and a tab, among other possible examples.

As another possibility, a GUI element may be an informational element through which information may be presented to a given user visually. A few illustrative examples of informational elements include a lists, a table, a graph, a sidebar, a progress indicator (e.g., a progress bar that indicates an extent to which a process which is currently being performed has been completed), a header, a footer, a card (e.g., a hover card that appears when a given user mouses over a particular element in a GUI), text, an image, text, an infographic, a notification (e.g., a toast notification that appears for a short period of time), a container (e.g., a window, a panel, and a tear sheet), among other possible examples.

Note that the types of GUI elements listed above are not mutually exclusive and, in some instances, may be included within each other or combined in other ways. A given container, for example, may contain any number of GUI elements of any type. In another example, a toolbar may serve as both an informational element (e.g., by showing indicia of available tools) and an input-control element (e.g., by allowing the given user to activate a given tool by clicking on an icon that represents the given tool). Many other examples are also possible.

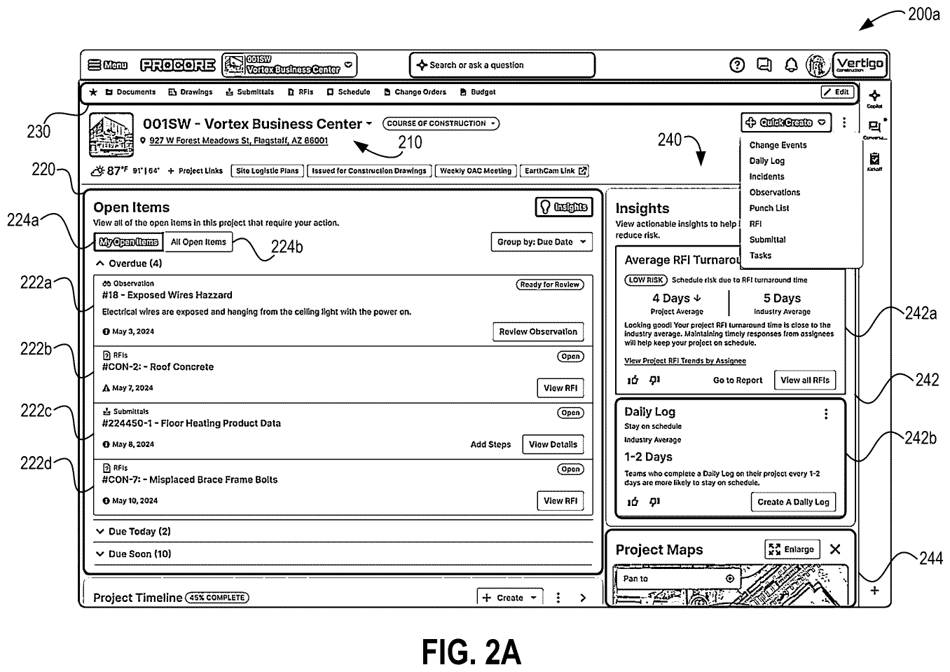

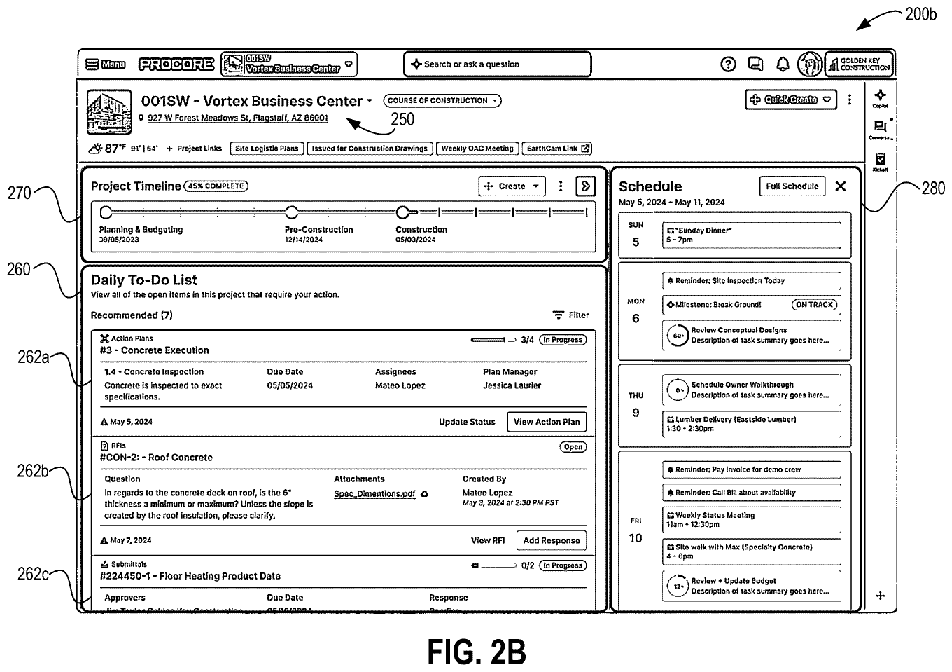

Turning to FIG. 2A, a GUI view 200a provides an illustrative example of a project-overview GUI view that provides overview-level information about a construction project in which a party is involved, according to the present disclosure.

As shown, the GUI view 200a includes a header 210 that includes a project name and a project address. Furthermore, the GUI view 200a includes a card 220 entitled “Open Items.” The card 220 contains cards 222a-d. As shown, each of the cards 222a-d indicates a type of data object (e.g., item), respectively, to which the card corresponds. Specifically, the card 222a corresponds to an observation, the card 222b corresponds to an RFIs, the card 222c corresponds to a submittal, and the card 222d corresponds to an RFI. Furthermore, each of the cards 222a-d includes a respective title for the respective data object to which it corresponds and a respective button for accessing the respective data object. The button for accessing the data object to which the card 222a corresponds is labeled as “Review Observation,” while the button for accessing the data object to which the card 222b corresponds is labeled as “view RFI.”

The card 220 also includes radio buttons 224a-b (labeled as “My Open Items” and “All Open Items,” respectively) that facilitate switching between viewing the given user's open items alone (e.g., as shown) and viewing both the given user's open items and other users'open items together in the card 220.

The GUI view 200a also includes a toolbar 230 that is positioned above the header 210 and a sidebar 240. The toolbar 230 includes buttons for accessing, editing, and/or creating certain types of data objects (e.g., submittals, RFIs, change orders, etc.).

The GUI view 200a also includes a sidebar 240. The sidebar 240 includes a card 242 (“Insights”) and a card 244 (“Project Maps”). The card 242 includes a card 242a (which indicates an average RFI turnaround time as shown) and a card 242b (which indicates an industry average time for completion of daily logs).

A client device may render a given GUI view (e.g., the GUI view 200a) on an electronic display by utilizing a set of configuration data that defines the given GUI view. The set of configuration data may indicate, for example, the GUI elements to be displayed and a respective type for each GUI element. Furthermore, the set of configuration data may indicate a layout that specifies how the GUI elements are to be arranged across a display area. For instance, the set of configuration data may include a respective size, a respective location, and/or a respective orientation for each GUI element. If any overlapping GUI elements are to be displayed in the given GUI view, the set of configuration data may specify a stacking order for those overlapping GUI elements (e.g., to indicate which overlapping GUI element is to be shown at the front, which GUI element is to be shown at the back, etc.). In addition, the set of configuration data may specify content to be displayed within informational elements. If such content includes text, the set of configuration data may specify values for parameters such as font, font size, font color, typeface, kerning, and other parameters that govern how the text is to be displayed. Depending on the schema that a given GUI uses for specifying set of configuration data, the GUI may have the capacity to generate hundreds or even thousands of different variations of GUI views.

As one example scenario, the given GUI may utilize cascading style sheets (CSS) and hypertext markup language (HTML) to specify at least part of the set of configuration data for a Given GUI view that is a page of a website. In this scenario, the parameters (e.g., properties) whose values may be varied to specify different versions of a Given GUI view are legion. For instance, CSS includes parameters for text properties (e.g., color, font-family, font-size, font-weight, text-align, text-decoration, and text-transform), box model properties (e.g., width, height, margin, padding, border, and box-sizing), background properties (e.g., background-color, background-image, background-repeat, background-position, and background-size), positioning properties (e.g., position, top, right, bottom, left, and z-index), layout properties (e.g., display, flex, flex-direction, grid-template columns, and grid-template rows), image properties (e.g., opacity and background-image), list properties (e.g., list-style-type, list-style-position, and list-style-image), table properties (e.g., border-collapse, border-spacing, and table-layout), animation properties (e.g., animation-name, animation-duration, animation-timing-function, animation-delay, animation-iteration-count, and animation-direction), transition properties (e.g., transition-property, transition-duration, transition-timing-function, and transition-delay), and other properties (e.g., cursor, visibility, and overflow). These parameters provide many degrees of freedom along which a given GUI view may be varied to satisfy the demands and preferences of both parties (e.g., companies) and users (e.g., individual persons) alike.

Other schemas for specifying the set of configuration data are also possible.

Despite the potential that exists for varying GUI views, existing construction management software applications do not leverage this potential to tailor different versions of a Given GUI view for different users. However, the types of data that are of interest to a given user who accesses a construction management software application and the specific tasks that the given user has been engaged to perform via the construction management software application may vary widely from user to user.

To illustrate how widely such data of interest and assigned tasks may vary from user to user, consider an example in which a given party serves as a general contractor for a given construction project. In this example, the given party may engage the services of any combination of users to fill various roles for a given construction project, such as a project manager, a structural engineer (e.g., who specializes in determining the strength and durability of building structures), a building engineer (e.g., who specializes in incorporating utilities and services into buildings), an occupational safety representative, and/or tradespersons (e.g., carpenters, masons, welders, plumbers, electricians, heavy equipment operators, plasterers, painters, demolition experts, elevator constructors, insulation installers, heating-ventilation-and-air-conditioning (HVAC) technicians, fencers, carpet layers, drywall hangers, architects, engineers, etc.), among other possibilities. The data of interest and the tasks for any given user may depend, at least in part, on the role(s) that the given party has engaged the given user to perform with respect to the given construction project. Furthermore, the given party may delegate different tasks to different users who have similar roles and/or specialties (e.g., the given party may delegate the task of framing a particular building to a first carpenter and the task of installing cabinets to a second carpenter). The permissions that the party's representative designates for a given user may align with the role(s) the given user has been engaged to fill and/or the tasks the given user has been assigned to perform to ensure that the given user has sufficient permissions to fill those role(s) and perform those tasks. The party's representative may also choose to designate that the given user does not have any extraneous permissions that are unrelated to those role(s) and/or tasks (e.g., to ensure that the given user does not mistakenly alter data that the given user is not authorized to alter, to ensure that data that is not pertinent to the given user is not presented to the given user so that the given user does not have to navigate through a thicket of irrelevant information to locate data of interest, etc.).

In general, as suggested by the example above, the project data that a given user will access and the tasks that the given user will perform within a construction management application may vary widely based on a number of factors.

One such factor may be who the given user's employer is and which particular set of tasks the given user's employer has been engaged to perform (e.g., in accordance with one or more trades in which the employer provides services). The tasks that the given user will perform via the software application will likely be a subset of the tasks the employer was engaged to perform. For instance, consider an example in which the given user's employer was engaged to provide carpentry services for the given construction project. In this example, the given user may use the software application to access data related to carpentry and to perform a subset of the tasks related to carpentry.

Another factor may be the specific role that the given user has been assigned on the construction project (e.g., for the given user's employer). For instance, consider an example in which the given user's employer has been engaged to perform carpentry services and the given user is a joister. The given user is likely to use the software application to access data related to floor joists and to perform tasks pertinent to floor joists.

Yet other factors may be attributes of the given construction project itself, such as work type (e.g., whether a project pertains to a renovation to an existing structure, an addition to an existing structure, a new structure, or a shell of a structure), construction type (e.g., a project's construction type as defined by an industry standard or by the laws of one or more jurisdictions), and/or occupancy code (e.g., a project's occupancy code as defined by an industry standard such as the International Building Code (IBC) provided by the International Code Council (ICC)), among other possibilities. For instance, consider an example in which the given construction project is a renovation to an existing structure and the given user is a mason. In this example, the given user may use the software application to access related to masonry and to perform tasks related to masonry, but the given user might not perform specific masonry tasks that may be uncommon for renovation projects (e.g., pouring a foundation) despite those specific masonry tasks being common for other types of projects (e.g., new constructions).

Other factors may also influence the project data that a given user will access and the tasks that the given user will perform within a construction management software application throughout the duration of a construction project (e.g., as will be discussed further below).

Given the complexity of many construction projects, the different types of data that may be of interest to different users, and the different types of tasks for which different users may use a construction management software application, the challenge of designing software that will seamlessly provide a satisfactory quality of experience (QoE) for such different users in an integrated, coherent application is not trivial.

In particular, although the types of data that may be of interest to different users and the types of tasks for which different users may use a construction management software application vary widely, there is little, if any, functionality available for customizing the layout of a given GUI view (e.g., the types of GUI elements presented within the given GUI view and the arrangement in which those GUI elements are presented) and the content to be displayed in the given GUI view for different users and parties. Furthermore, existing construction management software applications lack predictive functionality for determining which possible version or versions of a given GUI view are most likely to result in a satisfactory QoE for a given user.

This lack of customization functionality poses a number of problems. For example, if the layout of a given GUI view is not personalized for a given user, the given user may struggle to find the aspects of a given GUI view that are pertinent to a task the given user wishes to complete at a given time when the given user accesses the construction management software. As a result, the given user may lose valuable time. Furthermore, the given user may be obliged to take superfluous actions to complete the task. In addition, if the content displayed in the given GUI view is not personalized to the given user, irrelevant content may displace relevant content, clutter the given GUI view, and inhibit the given user's ability to use the construction management application in an efficient manner. The given user may be left with little choice but to comb through a metaphorical haystack of irrelevant content and/or functionality to locate a metaphorical needle of relevant content and/or functionality which the given user hopes to access to accomplish the task.

As one example of how a given user may encounter such a problem, consider a scenario in which the given user is a plumber who has received a change order for a given construction project. In this scenario, imagine that the change order specifies that a drainage pipe with a four-inch diameter be used in place of a drainage pipe with a two-inch diameter that was described in a specification for the given construction project. Further imagine that the planned route of the drainage pipe passes adjacent to a load-bearing wooden beam and that a portion of the beam would have to be cut out to accommodate the increased diameter of the drainage pipe if the planned route is to be used. The plumber may open a construction management software application to find information for verifying whether state, local, and/or federal building codes would permit a sufficiently large portion of the beam to be cut out. Even if the construction management software application includes digitally searchable copies of the applicable building codes, the software lacks functionality to take the plumber's trade into account and present the plumber with a personalized GUI view that presents content most likely to be of interest for plumbers who are looking into building codes. As a result, a majority of the content displayed in a given GUI view may be inapposite to the plumber's purpose. The plumber may be obliged to spend an inordinate amount of time scrolling though text displayed in a scroll box, experimenting with using different terms in a search field, and/or clicking through various pages of content to find the applicable codes of interest.

As another example, consider a scenario in which an inspector who is an employee of a general contractor that is handling a construction project opens a construction management software application on a mobile device while on site at the construction project at a time that is within an hour of the end of the current business day. Given factors such as the inspector's role, the inspector's employer, the portable nature of the mobile device used to open the application, the current location (e.g., on site) of the mobile device, and the current time of day, it may be likely that the inspector's objective for opening the application on the mobile device is to create a punch list. Existing construction management software lacks functionality for personalizing a given GUI view in a way that takes these factors into account. As a result, the inspector may be obliged to navigate through at least a default first GUI view (e.g., an application landing page) and possibly through several other GUI views to arrive at the given GUI view that includes an input-control GUI element that triggers creation of a punch list. Even if the inspector manages to navigate to the given GUI view successfully, the inspector may further be obliged to click through several layers of a hierarchical list box (e.g., which includes a hierarchy of available functions that can be triggered from the given GUI view) in order to uncover the input-control GUI element that can be used to trigger the creation of a punch list—and if the inspector is unfamiliar with the hierarchy, the inspector might not even realize that the given GUI view includes the input-control GUI element. As a result, the inspector may have to spend an inordinate amount of time to locate the GUI element within the software application.

Many other examples of problems that result from lack of customization functionality and predictive functionality related to GUI views are possible. Such problems may cause a construction management software application to be inefficient for serving the varied purposes of different users. Furthermore, such problems may result in an unsatisfactory QoE for users.

To address these and other problems with existing construction management software applications, disclosed herein is new software technology for personalizing GUI views that are presented to a given user of a construction management software application.

At a high level, the disclosed technology may involve (i) determining that a given user has requested access to a given GUI view of a construction management software application, (ii) obtaining a set of baseline GUI data for the given GUI view, which may include data indicating a general purpose of the given GUI view, data indicating a type of content to be presented via the given GUI view, data indicating user actions that are to be supported by the given GUI view, and perhaps also data indicating a baseline layout of the given GUI view (e.g., in terms of the types of UI elements and the layout of such UI elements), (iii) obtaining a set of feature data for use in personalizing the given GUI view for the given user, (iv) obtaining a set of payload data including content to be made available to the given user via the given GUI view, (v) based on the set of baseline GUI data for the given GUI view, the set of feature data, and the set of payload data, generating a personalized version of the given GUI view (which may differ from a “default” version of the given GUI view that would otherwise be presented if no personalization is done), and (vi) causing the personalized version of the given GUI view to be presented to the given user (e.g., by transmitting the set of configuration data to a client device through which the given user is accessing the construction management software application along with an instruction to render the personalized version of the given GUI view).

The set of feature data for use in personalizing the given GUI view for the given user may include any of various different types of features that provide insight into how the given user is likely to interact with the given GUI view, examples of which may include (1) user-level features that provide information about the given user that is accessing the given GUI view, (2) party-level features that provide information about the party with which the given user is associated, (3) project-level features that provide information about the construction project(s) for which the given GUI view is being accessed, and (4) similar-user features that provide information about other users who, compared to the given user, are similarly situated (e.g., other users having the same job role as the given user).

Further, in at least some implementations, the function of generating the personalized version of the given GUI view may be carried out using an artificial intelligence (AI) model architecture that is configured to generate a personalized version of the given GUI view based on (i) the set of baseline GUI data for the given GUI view and (ii) the set of feature data for use in personalizing the given GUI view for a given user.

Advantageously, this software technology for personalizing GUI views that are presented to a given user of a construction management software application overcomes several of the drawbacks with existing construction management software applications that are discussed above. For instance, this software technology can predictively identify layouts and GUI elements that are likely to facilitate highly efficient user interactions with the application, thereby reducing the number of inputs (e.g., clicks, scrolling actions, mouseovers, etc.) that users have to provide to the application to accomplish tasks that align with users'objectives. Furthermore, this software technology can predictively differentiate between content that is likely to be relevant for a given user and content that is likely to be irrelevant for the given user. The software technology can further generate a set of configuration data to create a personalized view for a given user that incorporates an identified layout, identified GUI elements, and content that is likely to be relevant for the given user into a personalized GUI view based on the set of feature data.

Turning to FIG. 2B, the personalized GUI view 200b is an illustrative example of a personalized version of the GUI view 200a of FIG. 2A that is produced by the disclosed software technology.

Similar to the GUI view 200a of FIG. 2A, the personalized GUI view 200b includes a header 250 that includes the same project name and project address. However, unlike the GUI view 200a of FIG. 2A, the personalized GUI view 200b does not include a toolbar above the header 250. In this respect, the lack of a toolbar above the header 250 indicates that the disclosed technology omitted such a toolbar based on its analysis of the set of feature data (e.g., feature data indicating the given user for whom the personalized GUI view 200b was generated seldom used the toolbar 230 during historical interactions between the given user and the GUI view 200a).

Similar to the GUI view 200a of FIG. 2A, the personalized GUI view 200b includes a card 260 that contains cards 262a-c that correspond to data objects. However, unlike the card 220 of FIG. 2A, the card 260 is entitled “Daily To-Do List” instead of “Open Items.” This indicates that the disclosed technology changed the title of the card 260 based on its analysis of the set of feature data (e.g., feature data indicating that the given user is more likely to complete tasks associated with data objects whose corresponding cards are included in the card 260 in a timely fashion if the card 260 is entitled “Daily To-Do List” instead of “Open Items”). Furthermore, unlike the card 220 of FIG. 2A, the card 260 does not include radio buttons for switching between viewing the given user's open items alone and viewing both the given user's open items and other users'open items together. This indicates that the disclosed technology omitted the radio buttons based on its analysis of the set of feature data (e.g., feature data indicating that the given user seldom, if ever, chose to view both the given user's open items and other users'open items together during historical interactions between the given user and the GUI view 200a).

In addition, the cards 262a-c differ from the cards 222a-d of FIG. 2A in several ways. For instance, the cards 222a-d include titles for the respective data objects to which they correspond, but do not include other content from the respective data objects. By contrast, the cards 262a-c include additional content from the respective data objects to which the cards 262a-c correspond. For instance, the card 262b includes a question that was posed in the RFI to which the card 262b corresponds. This indicates that the disclosed technology added the additional content based on its analysis of the set of feature data (e.g., feature data indicating that the given user frequently reads questions posed in RFIs). In addition, although the cards 222a, 222b of FIG. 2A also correspond to respective RFIs, the button included on the card 262b for accessing the respective RFI is labeled as “Add Response” instead of “View RFI.” This indicates that the disclosed technology changed the label based on its analysis of the set of feature data (e.g., feature data indicating that the given user, after reading the question included RFIs, frequently activates functionality for responding to those RFIs). By including the question that was posed in the RFI in the card 262b and including a button for responding to the RFI in the card 262b. the personalized GUI view 200b allows the given user to avoid visiting a different view to initiate adding a response to the RFI. Also note that, unlike the cards 222a, 222b, the card 262b includes a link to a PDF file associated with the RFI to which the card 262b corresponds. This indicates that the disclosed technology added the link to the PDF file based on its analysis of the set of feature data (e.g., feature data indicating that the given user is likely to access that a PDF file that is associated with an RFI before adding a response to the RFI).

The personalized GUI view 200b also places a card 270 entitled “Project Timeline” above the card 260. This indicates that the disclosed technology prioritized displaying the card 270 above the card 260 based on its analysis of the set of feature data (e.g., feature data indicating that the given user habitually views a project timeline first before viewing the cards for the “Open Items” included in the card 220 of FIG. 2A).

Unlike the GUI view 200a of FIG. 2A, the personalized GUI view 200b does not include a card for “Insights” nor a card for “Project Maps.” Instead, the personalized GUI view 200b includes a card 280 labeled “Schedule” that includes cards that correspond to days. This indicates that the disclosed technology omitted cards for “Insights” and “Project Maps” and included the card 280 based on its analysis of the set of feature data (e.g., feature data indicating that the given user seldom interacted with the cards for “Insights” and “Project Maps” during historical interactions with the GUI view 200a of FIG. 2, but frequently viewed the project schedule when using the construction management software application).

These comparisons of the GUI view 200a of FIG. 2A to the personalized GUI view 200b of FIG. 2B and the explanations of why there are differences are provided merely for illustrative purposes. The disclosed technology may personalize GUI views in many other ways based on many other possible types of patterns that the disclosed technology may detect in the set of feature data.

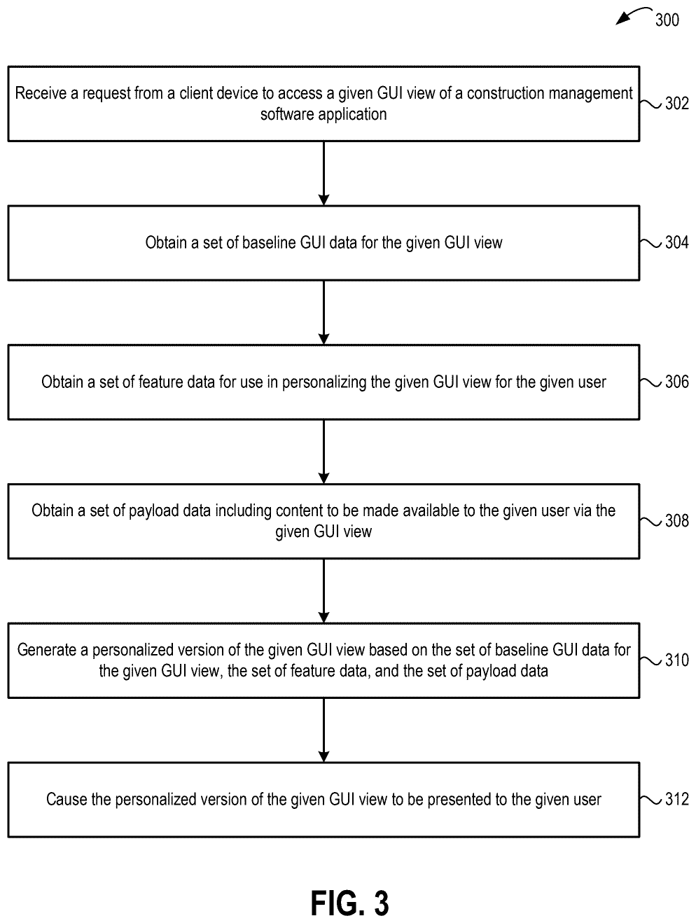

Turning to FIG. 3, example functionality 300 is illustrated in the form of a flow diagram. For purposes of illustration, the example functionality 300 of FIG. 3 is described as being carried out by the back-end computing platform 102 of FIG. 1, which is hosting a construction management software application, but it should be understood that the example functionality 300 of FIG. 3 may be carried out by any computing platform that is capable of running the software disclosed herein. Further, it should be understood that the example functionality of FIG. 3 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 3, the example functionality 300 may begin at block 302 with the back-end computing platform 102 receiving a request from the client device 104A to access a given GUI view of the construction management software application. The client device 104A may be associated with a given user of the construction management software application. The request may take the form of one or more request messages (e.g., one or more HTTP messages) that are sent over the communication path between the client device 104A and the back-end computing platform 102 and, in at least some implementations, the request may comprise one or more messages sent via one or more APIs. The client device 104A may send the request to the back-end computing platform 102 in response to an input received via an I/O component that is a part of, or is in communication with, the client device 104A. The input may take any of various forms.

For instance, as one possibility, if the I/O component is a touch screen, the input may be received when the given user taps on an icon (or some other input-control element) that is displayed on the touch screen. As another possibility, if the I/O component is a mouse, the input may be received when the given user (i) moves a cursor displayed on a screen over an icon that is associated with the construction management software application and (ii) clicks on the icon (or other input-control element). As another possibility, if the I/O component is a keyboard, the input may be received when the given user presses a hotkey associated with the construction management software application, enters a command to open the construction management software application via a command prompt, or presses enter (or some other key) to submit credentials (e.g., a username and password) that the given user has typed into one or more text fields configured to receive those credentials. Persons of skill in the art will recognize that the input may also take other forms to cause the client device 104A to send the request to the back-end computing platform 102.

The given GUI view may take any of various forms. For instance, as once possibility, the given GUI view may be a landing page that provides the given user with various informational elements, such as a list of construction projects for which the given user has been granted access permissions (e.g., by a representative of the party that holds the account through which the given user has been granted access to the construction management software application). The landing page may further include informational elements that specify attributes of the listed construction projects, such as project names, project addresses, project identifiers (e.g., project identification numbers), project statuses, and/or other information. The landing page may also include input-control elements for filtering the informational elements shown on the page. For example, one input-control element may provide options for filtering the listed construction projects according to one or more attribute values. Another input-control element may provide options for filtering the project attributes (e.g., so that more or fewer attributes are shown for the listed construction projects). Yet another input-control element may allow the given user to log out of the construction management software application. In addition, the landing page may include navigational elements through which the given user may navigate to other GUI views within the construction management software application, such as respective project-overview GUI views for the listed construction projects. Other informational elements, navigational elements, and input-control elements may also be provided on the landing page.

As another possibility, the given GUI view may be a project-overview page for a given construction project for which the given user has been granted access permissions. The project-overview page may include various informational elements, such as a list of parties who are involved in the given construction project and values of corresponding attributes for the listed parties (e.g., names, party roles, contact information such as phone numbers and/or email addresses, etc.). The informational elements in the project-overview page may further include a list of dates for the given construction project and respective names and/or descriptions that indicate why the dates may be of interest. In addition, informational elements such as graphs and/or charts may be included to provide information about various aspects of the given construction project. For instance, a stacked bar chart may be used to illustrate the current status of data objects of a particular type relative to one or more time parameters. As one example, a stacked bar chart may include a bar for RFIs. The bar may be divided into sub-bars of three different colors, where (i) the sub-bar of a first color indicates how many RFIs in the given construction project have been awaiting responses for more than a first threshold amount of time, (ii) the sub-bar of a second color indicates how many RFIs in the given construction project have been awaiting responses for less than the first threshold amount of time, but more than a second threshold amount of time; and (iii) the sub-bar of a third color indicates how many RFIs in the given project have been awaiting a response for less than the threshold period of time. Stacked bar charts for other types of data objects may similarly use the colors of sub-bars to indicate statuses relative to more or fewer time parameters. Many other examples of graphs, charts, and other types of informational elements may also be included in the project-overview page.

The project-overview page may also include navigational elements. For example, if a stacked bar chart is used, each sub-bar in the stacked bar chart may be a navigational element that, when clicked, causes the construction management software application to render a page with more information about the data objects indicated by the sub-bar to be rendered. Other types of navigational elements may also be included in the project-overview page.

The project-overview page may also include one or more input-control elements, such as a button for loading additional informational elements that are not displayed on the project-overview page by default. Other types of input-control elements may also be included in the project-overview page.

As another possibility, the given GUI view may be a tool-specific page through which data objects of a certain type (e.g., RFIs, punch lists, directories, invoices, timesheets, meeting minutes, daily logs, etc.) may be created via a corresponding software tool. For example, if the tool-specific page is configured for creating RFIs, the tool-specific page may include one or more informational elements that indicate the tool-specific page may be used to create RFIs. In addition, the tool-specific page may include input-control elements such as an editable multiline text field in which the given user may enter text (e.g., free-form text and/or natural-language text) that specifies information that the given user is requesting via the RFI. Another input-control element may allow the given user to specify a particular party and/or user from whom the information is being requested. Yet another input-control element may be a button that allows the given user to submit the information that the given user has provided via the editable multiline text field. The tool-specific page may also include navigational elements (e.g., a cancel button, a back button, a breadcrumb, etc.) that allows the given user to navigate to a different GUI view within the construction management software application.

Other forms of GUI views are also possible.

At block 304, the back-end computing platform 102 obtains a set of baseline GUI data for the given GUI view. The set of baseline GUI data may comprise one or more types of data and may take any of various forms.

For instance, the set of baseline GUI data may include types of data such as data that indicates a general purpose of the given GUI view (e.g., data that indicates that the given GUI view is a project-overview page, a landing page, a tool-specific page for a particular tool, etc.), data indicating a type of content to be presented via the given GUI view (e.g., text, images, graphs, tables, etc.), data that indicates user actions that are to be supported by the given GUI view (e.g., actions that users should be able to activate through elements of the given GUI view) , and/or data indicating a baseline layout of the given GUI view (e.g., whether the baseline layout is a single-column layout or a multi-column layout, whether the baseline layout includes a header and/or footer, whether the baseline layout includes a sidebar, etc.). The set of baseline GUI data may also include other types of data.

The set of baseline GUI data may be represented in any of various forms. For instance, portions of the configuration may include Javascript Object Notation (JSON) attributes, descriptive metadata, HTML elements such as containers (e.g., elements such as such as a title, a head, a body, headers, paragraphs, lists, flexboxes, divisions, and other elements which comprise respective opening and closing HTML tags to bound the content contained therein), selectors and properties that apply to content and other elements indicated thereby (e.g., in CSS), program code (e.g., in Javascript, PHP, etc.)

The manner in which the back-end computing platform 102 obtains the set of baseline GUI data may take various forms. For instance, as one possibility, the back-end computing platform 102 may load the set of baseline GUI data from a data store that is either included within the back-end computing platform 102 or is remote from the back-end computing platform 102. The manner in which the back-end computing platform 102 obtains the set of baseline GUI data may also take other forms.

At block 306, the back-end computing platform 102 obtains a set of feature data for use in personalizing the given GUI view for the given user.

As noted above, the set of feature data for use in personalizing the given GUI view for the given user may include any of various different types of features that provide insight into how the given user is likely to interact with the given GUI view, examples of which may include (1) user-level features that provide information about the given user that is accessing the given GUI view, (2) party-level features that provide information about the party with which the given user is associated, (3) project-level features that provide information about the construction project(s) for which the given GUI view is being accessed, and (4) similar-user features that provide information about other users who, compared to the given user, are similarly situated (e.g., other users having the same job role as the given user).

User-level features may include features whose values provide information about the given user that is accessing the given GUI view, such as characteristics, behaviors, access levels, roles, preferences, and/or other information specific to the given user. Some illustrative examples of information that may be provided by possible user-level features include the given user's job role, the given user's access levels (e.g., within the construction management software application, which may have been designated by an administrator), the given user's location (e.g., as indicated by the client device the given user is currently using to access the construction management software application), the current time of day when the given user is accessing the construction management software application, the given user's selected language for the construction management software application, and/or one or more values indicating the given user's historical interactions with the construction management software application (e.g., clicks, scroll behavior, time spent on a particular part of an interface, zooming in or out, etc.), among other possibilities.

Party-level features may include features whose values provide information about the party (e.g., a company or some other type of organization) that is involved in the construction project and is the account holder of the account through which the given user has access permissions for using the construction management software application. For instance, in some examples, the party might be the given user's employer, sponsor, franchisor, or some other party on whose behalf the given user is authorized to work on the construction project(s) for which the given GUI view is being accessed. Some illustrative examples of possible information that may be provided by party-level features include a contractor type (e.g., general contractor or subcontractor) if the given user's associated party is a contractor, a business type (e.g., corporation, limited liability company, partnership, sole proprietorship, etc.) of the given user's associated party, one or more service types the party provides (e.g., carpentry, masonry, welding, plumbing, electrical, heavy equipment operation, plasterers, painting, demolition, insulation, HVAC, roofing, fencing, flooring, drywall, architecture, engineering, etc.), one or more party-size metrics (e.g., number of employees, revenue, production, invested capital, assets, market capitalization, etc.), party ownership type (e.g., publicly owned or privately owned), one or more locations (e.g., a location of the party's headquarters, a place of incorporation, one or more locations of satellite offices, one or more locations where the party is legally authorized to provide services, etc.), one or more languages (e.g., an official language for the party's contracts or other business documents, an official language of a jurisdiction in which the party's headquarters is located or in which the party is incorporated, one or more languages spoken by a threshold percentage of a population that resides in the location where the party's headquarters is located, one or more official languages of countries where the party provides services, etc.), and/or one or more parties with whom the party is associated (e.g., parties that have worked done work on one or more historical construction projects on which the party has also done work, parties with whom the party has a known contractual relationship, a parent company of the party, a subsidiary of the party, etc.), among other possible examples.

Project-level features may include features whose values provide information about the construction project(s) for which the given GUI view is being accessed. Some illustrative examples of information that may be provided by possible project-level features may include a project type (e.g., residential, commercial, mixed-use, institutional, industrial, heavy civil, etc.), a project size (e.g., as indicated by a metric such as a project cost or value in a particular currency, a project area as measured by a particular unit of distance squared, etc.), a project language (e.g., a designated language in which project documents are to be written) , a project location (e.g., as indicated by an address, zip code, Global Positioning System (GPS) coordinates, etc.), one or more project regions (e.g., a region in which the project is located, which may determine applicable building codes, laws, and other factors such as climate, ground stability/condition, etc.), an extent to which tasks for onboarding parties involved in the project have been completed (e.g., as indicated by a percentage of onboarding tasks completed or some other quantitative and/or ordinal metric), an extent to which the project has been completed relative to the project schedule (e.g., as indicated by a percentage of completion or some other quantitative and/or ordinal metric), a next task to be completed for the project (e.g., the task immediately following a last task completed in a sequence of tasks that defines a Critical Path such that a delay to any of the tasks in the sequence will cause a delay in completion of the project as a whole), and one or more project vitals (e.g., quantitative and/or ordinal metrics used to measure an extent to which a project is or will be considered successful, such as an extent to which the project is under or over budget, an extent to which the project is on schedule, an extent to which the project satisfies industry standards, etc.), among other possibilities.

Similar-user features may include features whose values provide information about other users who are similarly situated to the given user, such as characteristics, behaviors, preferences, and/or other information specific to other users who are deemed to be similar to the given user (e.g., users who have the same job role as the given user). The manner in which similarity to the given user is determined may involve evaluating whether one or more similarity conditions are satisfied and may take any of various forms.

For instance, as one possibility, the similarity between the given user and another user may be determined by treating user-level features as dimensions and calculating a value for a numeric metric (e.g., a Euclidean distance which may weighted or unweighted, a logarithmic distance, a cosine similarity, etc.). The other user may be considered sufficiently similar to the given user if the determined value numeric metric value is less than a threshold value (which may be predefined or may be determined dynamically to ensure that a threshold number of users are deemed to be sufficiently similar to the given user).

As another possibility, the similarity between the given user and another user may be determined by verifying that the given user and the other user have matching values for a specific user-level feature and/or for a combination of specific user-level features. For instance, in one example, the other user may be deemed sufficiently similar to the given user is the other user's role matches the given user's role. In another example, the other user may be deemed sufficiently similar to the given user if the other user's access permissions match the given user's access permissions. In yet another example, the other user may be deemed sufficiently similar to the given user if the other user's location matches the given user's location (e.g., if the other user's location is within a threshold distance of the given user's location). In yet another example, the other user may be deemed sufficiently similar to the given user if a threshold number of the other user's preferences match the given user's preferences.

As another possibility, the similarity between the given user and the other user may be determined based on a comparison of one or more patterns in the other user's historical interactions with the construction management software application to one or more patterns in the given user's historical interactions with the construction management software application. For instance, as one example, if a difference between average time the other user spends on a particular part of an interface and the average time the given user spends on the particular part of the interface in less than a threshold amount of time, the other user may be deemed sufficiently similar to the given user. In another example, if the other user uses a particular software tool within the construction management software application with a frequency that differs from the frequency with which the given user uses the particular software tool by less than a threshold value, the other user may be deemed sufficiently similar to the given user.

Other forms of determining similarity to the given user are also possible.

Returning to the set of feature data (which, as noted above, may comprise user-level features, party-level features, project-level features, and/or similar-user features), the set of feature data may comprise feature values (e.g., actual parameters) that map to corresponding feature variables (e.g., formal parameters). The manner in which feature values for the given user (and for other user deemed sufficiently similar to the given user) are determined may vary in accordance with the types of feature variables to which those feature variables map.

For instance, as one possibility, consider a scenario in which a given feature variable directly represents a datum about the given user that is stored in a profile for the given user. For example, in this scenario, imagine that the given feature variable represents a role of the given user (e.g., selected from a predefined set of possible roles). In this scenario, the back-end platform 102 may retrieve the datum from the user profile and use the role of the given user as encoded in the profile as the feature value for the given feature variable. If the scheme that is used to encode the role in the profile differs from the scheme that is used to encode the role as a feature value for the feature variable that the AI model is configured to receive as input, the back-end platform 102 may convert the role from the encoding used in the profile to the encoding that the AI model is configured to receive as input.

As another possibility, determining a feature value for a given feature variable may involve one performing one or more calculations on data associated with the given user, such as data stored in a profile for the given user and historical interaction data for the given user (e.g., which represents historical interactions between the given user and the construction management software application).

For example, consider a scenario in which the given feature variable represents the number of times the given user has clicked on a particular type of input-control element in the past month. In this scenario, the back-end computing platform 102 may calculate the feature value for the given feature variable by loading historical interaction data for the given user for the past thirty days and determining a count of clicks that the given user made on input-control elements of the particular type during those thirty days. The count of clicks may serve as the feature value.

In another example, the given feature variable may represent the average number of inputs the given user has historically provided to the construction management software application per unit of time. In this example, the back-end computing platform 102 may retrieve the historical interaction data for the given user and determine a count of input events (e.g., clicks) recorded in the historical interaction data. In addition, the back-end computing platform 102 may determine a sum of interaction times (e.g., as measured in seconds, minutes, and/or hours) for the interactions recorded in the historical interaction data. Next, the back-end computing platform 102 may determine the feature value for the given feature variable by determining a quotient of the count of input events divided by the sum of interaction times (e.g., by dividing the count by the sum).

In another example, the given feature variable may represent a probability that the given user will use a particular software tool in the construction management software application during an interaction session (e.g., a series of interactions occurring between a time when the given user logged in to the construction management software application and a time that the given user logged out of the construction management software application). In this example, the back-end computing platform 102 may retrieve the historical interaction data for the given user and determine a count of the total number of interaction sessions that are recorded therein. In addition, the back-end computing platform 102 may determine the number of interaction sessions in which the given user used the particular software tool. Next, to determine the feature value for the given feature variable, the back-end computing platform 102 may determine a quotient of the number of interaction sessions in which the given user used the particular software tool and the count of the total number of interaction sessions (e.g., by dividing the number of interaction sessions in which the given user used the particular software tool by the count).

Other manners for determining feature values for the given user (and for other users deemed sufficiently similar to the given user) are also possible.

Once the set of feature data has been determined (e.g., as described above), the set of feature data may be stored (e.g., in a data store).

The manner in which the back-end computing platform 102 obtains the set of feature data may take various forms. For instance, as one possibility, if the set of feature data has not yet been determined, the back-end computing platform 102 may determine the set of feature data accordingly (e.g., as described above). As another possibility, if the set of feature data has already been determined and stored, the back-end computing platform 102 may load the set of feature data from a data store that is either included within the back-end computing platform 102 or is remote from the back-end computing platform 102. The manner in which the back-end computing platform 102 obtains the set of feature data may also take other forms.

Note that the obtained set of feature data may, in some instances, be formatted in various ways formats and/or projected into different ranges of values (e.g., by one or more transformations) in order to serve as input (e.g., feature values) that will be compatible with an AI model. The formats and value ranges may take various forms. For example, some feature data may be transformed into a numeric format (e.g., integer, decimal, or fraction) and projected into a predetermined range of values (e.g., a range from zero to one, a range from zero to one hundred, etc.). As another example, some feature data may be transformed into a categorical format based on predefined categories. Other formats and value ranges are also possible.

At block 308, the back-end computing platform 102 obtains a set of payload data including content to be made available to the given user via the given GUI view. The set of payload data and the content therein may take any of various forms. For instance, as one possibility, the set of payload data may include text to be presented in one or more elements of the given GUI view, such as a text to be presented in headings, subheadings, sidebars, lists, cards, dialog balloons, and/or other elements that have the capacity to display text therein. As another possibility, the set of payload data may include media (e.g., images, video, etc.), source data for charts (e.g., data that may be used to for populating graphs and/or charts, such as data sets comprising tuples such that each tuple includes one or more measurements made on a corresponding sampling unit in a statistical sample), and other data that is to be made available for presentation to the given user within the given GUI view. Note that text and/or media in the set of payload data may include data objects (e.g., specifications, drawings, BIM files, RFIs, punch lists, directories, invoices, timesheets, meeting minutes, daily logs, etc.) or portions thereof.

The back-end platform 102 may, in some examples, extract one or more semantic meanings from textual content included in the payload data (e.g., text found in portions of data objects included in the payload data) and/or textual content included in the request (e.g., such as natural-language instructions included in a prompt found in the request). The back-end platform 102 may represent the one or more semantic meanings via one or more contextualized word embeddings (e.g., generated via Bidirectional Encoder Representations from Transformers (BERT) or Generative Pre-trained Transformers (GPT)) and/or logical expressions (e.g., expressed formally in predicate logic, lambda calculus, or some other formal scheme for representing logic).

At block 310, the back-end computing platform 102 generates a personalized version of the given GUI view based on the set of baseline GUI data for the given GUI view, the set of feature data, and the set of payload data. In examples where one or more semantic meanings have been extracted from textual content included in the set of payload data and/or the request, the back-end platform 102 may generate the personalized version of the GUI view based on the one or more semantic meanings in addition to the set of baseline data, the set of feature data, and the set of payload data. The personalized version of the given GUI view may comprise (i) a personalized set of GUI elements included within the given GUI view, (ii) a personalized set of content presented via the given GUI view, and/or or (iii) a personalized layout of the given GUI view. Note that the personalized set of content may include a full version of the content included in the payload data or may include less than the full version of the content included in the payload data. Furthermore, the personalized set of content may include additional content that was retrieved (e.g., from storage) by or generated by the back-end computing platform 102 in addition to the content included in the payload data. For instance, as one example, the back-end computing platform 102 may include data from additional data objects that were not included (either in whole or in part) in the content included in the payload data. The back-end computing platform 102 may include the additional data objects based on one or more detected relationships between the additional data objects and data objects that are referenced in the content included in the payload data. The relationships may be detected via a knowledge graph such as the knowledge graphs described in U.S. patent application Ser. No. 17/307,869, filed on May 1, 2021 and entitled “Construction Knowledge Graph,” which is hereby incorporated by reference in its entirety. Also, in another example, the back-end computing platform 102 may include data that is retrieved by or generated by the back-end computing platform 102 based on the content included in the payload data (e.g., a summary of the content included in the payload data generated by a Large Language Model (LLM)), the set of baseline GUI data, and/or the set of feature data.

The personalized version of the given GUI view may be represented in terms of a set of configuration data that defines (and can be used to render) the personalized version of the given GUI view. For example, the set of configuration data may include data defining a set of GUI elements to be included in the given GUI view, an arrangement in which the GUI elements are to be included in the given GUI view, and/or a set of content to be presented via the given GUI view, where one or more of these aspects of the given GUI view have been personalized for the given user. Such a set of configuration data could be encoded in a format such as HTML, JSON, or the like.

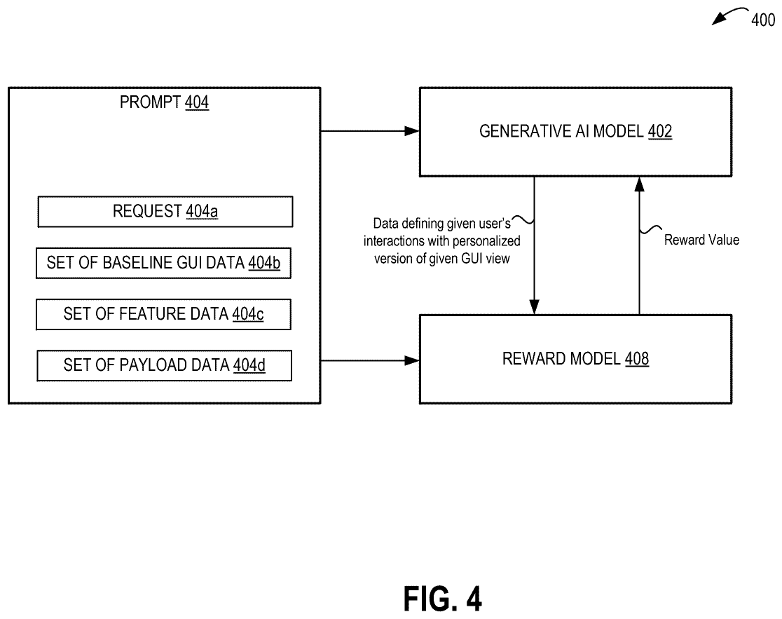

As noted above, in one example, the personalized version of the given GUI view may be generated using an AI model architecture that is configured to generate a personalized version of the given GUI view based on (i) a set of baseline GUI data for the given GUI view, (ii) a set of feature data for use in personalizing the given GUI view for a given user, and/or a set of payload data including content to be made available to the given user via the given GUI view. Such an AI model architecture may comprise any of various types of AI models, including but not limited to any of various types of generative AI models (e.g., transformer-based models such as large language and/or large multimodal models, diffusion models, generational adversarial networks, variational autoencoders, etc.), which may themselves comprise underlying machine-learning models such as neural networks. Further, in some implementations, the AI model architecture may comprise a combination of multiple AI models (e.g., a generative AI model in combination with a rewards model or perhaps multiple types of generative AI models working in tandem). One example of an AI model architecture that may be utilized to generate the personalized version of the given GUI view in accordance with the present disclosure is shown and described below with reference to FIG. 4.

In this example, the function of generating the personalized version of the given GUI view may involve (i) using the set of baseline GUI data, the set of feature data, and the set of payload data to produce an input dataset for the AI model architecture, which may take the form of a prompt comprising a request and context for a generative AI model (among other possibilities), (ii) inputting the input dataset (e.g., the prompt) into the AI model architecture and thereby causing the AI model architecture to generate the personalized version of the given GUI view, which may be represented and output by the AI model architecture in the form of a set of configuration data that defines the personalized version of the given GUI view, and (iii) optionally performing post-processing operations on the set of configuration data for the personalized version of the given GUI view.

The function of generating the personalized version of the given GUI view may be carried out in other ways as well.

At block 312, the back-end computing platform 102 causes the personalized version of the given GUI view to be presented to the given user. The manner in which the back-end computing platform 102 causes the personalized version of the given GUI view to be presented to the given user may take many forms.

For instance, as one possibility, the back-end computing platform 102 may transmit a communication to the client device 104A (e.g., via the communication path between the back-end computing platform 102 and the client device 104A) that instructs the client device 104A to render the personalized version of the given GUI view (e.g., on a screen controlled by the client device 104A). The communication may include the set of configuration data that defines the personalized version of the given GUI view. In practice, this communication may take the form of one or more response messages (e.g., one or more HTTP messages) that are sent over the communication path between the back-end computing platform 102 and the client device 104A and, in at least some implementations, the communication may comprise one or more messages sent via one or more APIs.

Once the client device 104A receives the set of configuration data, the client device 104A renders the personalized version of the given GUI view based on the set of configuration data. The given user may view the personalized version of the given GUI view at the client device 104A and interact with the personalized version of the given GUI view by providing input through one or more I/O components of the client device 104A (e.g., by tapping or clicking on an input-control element and/or a navigational element included in the personalized version of the given GUI view). After receiving the input from the given user, the client device 104A may transmit data describing the interaction between the given user and the personalized version of the given GUI view (e.g., including an indication of the input provided by the given user).

In addition, the back-end computing platform 102 may receive (e.g., from the client device 104A via the communication path between the client device 104A and the back-end computing platform 102) the data describing the interaction between the given user and the personalized version of the given GUI view. The back-end computing platform 102 may store the data describing the interaction between the given user and the personalized version of the given GUI view so that the data may later be used to generate training data for the AI model.

Turning to FIG. 4, one example of an AI model architecture 400 that may be utilized to generate a personalized version of a given GUI view for a given user in accordance with the present disclosure is illustrated.

As shown, the example AI model architecture 400 may include a generative AI model 402 that is configured to receive a prompt 404 comprising (i) a request 404a to create a personalized version of the given GUI view for the given user, (ii) a set of baseline GUI data 404b for the given GUI view, (iii) a set of feature data 404c for use in personalizing the given GUI view for a given user, and/or (iv) a set of payload data 404d including content to be made available (e.g., for presentation) to the given user via the GUI view. Each of these components of the prompt 404 may take various forms.

For instance, the request 404a to create the personalized version of the given GUI view for the given user may take the form of an instruction or command to create a personalized version of the given GUI view, which may be identified in the request in terms of (i) a name of the given GUI view (e.g., a “Project Overview” view) or a description of the given GUI view (e.g., “a GUI view that provides an overview of my projects”) and perhaps also (ii) an identification of a particular construction project for which the given GUI view is being accessed (if the given GUI view is project-specific). In this respect, the back-end computing platform 102 may determine these aspects of the request 404a based on the received request to access the given GUI view and/or based on the set of baseline GUI data for the given GUI view, among other possibilities. Additionally, in some implementations, the request 404a may also specify a particular goal (or set of goals) for the personalized version of the given GUI view, such as a personalized version of the given GUI view that minimizes the number of user interactions with the given GUI view, a personalized version of the given GUI view that minimizes the amount of time spent by the given user while interacting with the given GUI view, or a personalized version of the given GUI view that encourages the given user to take a particular action, among other possibilities. The request 404a to create the personalized version of the given GUI view for the given user may include other aspects and/or take other forms as well.

Further, the set of baseline GUI data 404b for the given GUI view that is included in the prompt 404 for the generative AI model 402 may take any of various forms, including any of the forms described above (e.g., with respect to FIG. 3). For instance, in line with the discussion above, the set of baseline GUI data 404b may include data indicating a general purpose of the given GUI view, a type of content to be presented via the given GUI view, user actions that are to be supported by the given GUI view, and/or a baseline layout of the given GUI view, among other possibilities. In this respect, the set of baseline GUI data 404b may serve as one form of context for the request 404a.

Further yet, the set of feature data 404c for use in personalizing the given GUI view for the given user may take any of various forms, including any of the forms described above (e.g., with respect to FIG. 3). For instance, in line with the discussion above, the set of feature data 404c may include any one or more of (i) user-level features that provide information about the given user that is accessing the given GUI view, (ii) party-level features that provide information about the party with which the given user is associated, (iii) project-level features that provide information about the construction project(s) for which the given GUI view is being accessed, and/or (iv) similar-user features that provide information about other users who, compared to the given user, are similarly situated (e.g., other users having the same job role as the given user). In this respect, the set of feature data 404c may serve as another form of context for the request 404a.

Further yet, the set of payload data 404d including content to be made available to the given user via the GUI view may take any of various forms. For instance, the set of payload data 404d may include text to be presented in one or more elements of the given GUI view, such as a text to be presented in headings, subheadings, sidebars, lists, cards, dialog balloons, and/or other elements that have the capacity to display text therein. Also, the payload data 404d may include media (e.g., images, video, etc.), source data for charts (e.g., data that may be used to for populating graphs and/or charts, such as data sets comprising tuples such that each tuple includes one or more measurements made on a corresponding sampling unit in a statistical sample), and other data that is intended to be made available for presentation to the given user in the given GUI view. Note that at least part of the payload data 404d may be retrieved from data objects (e.g., RFIs, daily logs, etc.). For example, if one purpose of the given GUI view is to remind the given user about RFIs for which the given user has not yet provided a response, the set of payload data 404d may include text and/or other data retrieved from such RFIs.

The prompt 404 that is received is input by the generative AI model 402 may take various other forms as well. For instance, as one possibility, the request 404a portion of the prompt 404 may include additional details about the given GUI view and/or the given user that are generated by the back-end computing platform 102 based on the set of baseline GUI data 404b, the set of feature data 404c, and/or the set of payload data 404d, in which case a lesser extent (e.g., subset) of the set of baseline GUI data and/or the set of feature data may be passed in as context for the generative AI model 402. To illustrate with an example, the request 404a portion of the prompt 404 may comprise a description of the given GUI view to be generated that includes details sourced from the obtained set of baseline GUI data—such as the general purpose of the given GUI view, the type of content to be presented via the given GUI view, and/or the user actions that are to be supported by the given GUI view—in which case the prompt 404 may not include the set of baseline GUI data 404b as a separate component (or may include a narrowed subset of the set of baseline GUI data 404b). Or to illustrate with another example, the request 404a portion of the prompt 404 may comprise details sourced from the obtained set of feature data—such as details about the given user, the party with which the given user is associated, and/or the construction project(s) for which the given GUI view is being accessed—in which case the prompt 404 may not include the set of feature data 404c as a separate component (or may include a more narrowed subset of the set of feature data 404c). In yet another example, the request 404a portion of the prompt 404 may comprise content to be presented to the user via the given GUI view—in which case the prompt 404 may not include the set of payload data 404d as a separate component (or may include a more narrowed subset of the set of payload data 404d). Other forms of the prompt 404 are possible as well.

To further illustrate how the prompt 404 might appear, consider the following illustrative example. In this example, the prompt may be written (e.g., typed directly via a physical or virtual keyboard, transcribed from a speech command via voice-recognition software, etc.) as a paragraph in a natural language (e.g., English). A first sentence of the paragraph may read as “This request is for a project overview page of a data center project to be viewed on a mobile phone.” This first sentence specifies a name of the given GUI view (e.g., “This request is for a project overview page”), a type of construction project for the given GUI view (e.g., “of a data center project”), and a type of device on which the given GUI view is to be rendered (e.g., “to be viewed on a mobile phone”). A second sentence of the paragraph may read as “Let the page have a two-column layout and let it preview an open RFI.” This second sentence specifies an aspect of a layout (e.g., “a two-column layout”) and a type of data object (e.g., “an open RFI”). A third sentence of the paragraph may read as “For the north end of the site, provide, in an HTML format, a component that will help the user both (i) understand what has changed at the north end of the site in a minimal amount of time and (ii) perform an action via a minimum number of clicks.” This third sentence specifies a location (e.g., “the north end of the site”), an output format for a desired component (e.g., “an HTML format”), and two types of target interactions (e.g., “(i) understand what has changed at the north end of the site in a minimal amount of time and (ii) perform an action via a minimum number of clicks”). A fourth sentence of the paragraph may introduce a list of components by stating “Let the data representing the changes to the north end of the site and the action be presented by at least one of the following GUI components:” and proceed to list a first types of component as “(i) a timeline chart of changes,” a second type of component as “(ii) a comparison of a first image or drawing representing the north end of the site before the changes to a second image or drawing representing the north side of the site such that differences between the first and second images or drawings are highlighted,” and a third type of component as “(iii) a text summary that describes the changes, one or more recommended actions to be taken, and the reasons for which the one or more recommended actions are being recommended.”

Other examples of prompts (e.g., prompts that include more or less data and/or different types of data, prompts that include portions not specified in a natural language, etc.) are also possible.

The generative AI model 402 may then be configured such that, in response to receiving the prompt 404, the generative AI model 402 generates a personalized version of the given GUI view based on the information included in the prompt 404. In this respect, the generative AI model 402 may represent and output the personalized version of the given GUI view in the form of a set of configuration data that defines the personalized version of the given GUI view. This set of configuration data may take various forms.

As one possibility, the generated set of configuration data may comprise a full set of configuration data for rendering the personalized version of the given GUI view. As another possibility, the generated set of configuration data may comprise a partial set of configuration data for rendering the personalized version of the given GUI view, in which case certain post-processing operations may be performed in order to generate a full set of configuration data for rendering the personalized version of the given GUI view. For instance, the generated set of configuration data may include certain placeholder values for the defined UI elements—such as placeholder values for the content to be presented via the defined UI elements—which may then be populated with the appropriate values before the set of configuration data is sent to the client device 104 for rendering. As another possibility, the generated set of configuration data may comprise data for presenting one or more aspects of the personalized version of the given GUI view in an audio format (e.g., if the screen of a mobile device through which the given user is accessing the construction management software application has been deactivated while the user drives a motor vehicle, if an accessibility feature for persons with impaired vision has been activated on the mobile device, etc.). As another possibility, the generated set of configuration data may comprise data for presenting one or more aspects of the personalized version of the GUI view in a video format, an image format, a chart format, or a map format. The generated set of configuration data may also take other forms.

The generative AI model 402 may be configured to output the generated set of configuration data or a portion thereof in a data interchange format (e.g., JSON) , a markup language (e.g., HTML, XML, LaTeX, etc.), a programming language (e.g., a client-side programming language such as JavaScript or a server-side programming language such as PHP), and/or some other form that can be parsed by computers.

In line with the discussion above, the generative AI model 402 may comprise any of various types of generative AI models, examples of which may include a transformer-based model such as a large language and/or large multimodal model, a diffusion model, a generational adversarial network, and/or a variational autoencoder, each which may be comprised of underlying machine-learning models such as neural networks. Further, the generative AI model 402 could comprise a pre-trained generative AI model, a pre-trained generative AI model that is fine-tuned using domain-specific training data (e.g., training data that correlates baseline GUI data and feature data with personalized versions of GUI views), or a generative AI model that is trained in the first instance using domain-specific training data, among other possibilities. In this respect, the fine-turning and/or training of the generative AI model 402 may involve any of various types of machine-learning techniques, including but not limited to supervised, self-supervised, and/or unsupervised learning techniques.

In some implementations, the generative AI model 402 may also be configured to interact with a reward model 408 that is configured to (i) receive, as input, data defining a given user's interactions with a personalized version of a given GUI view that is generated by the generative AI model 402, (ii) generate a “reward” value (or “score” value) for the personalized version of a given GUI view based on the given user's interactions, and (iii) feed the reward value back to the generative AI model 402, which then uses the reward value to refine its generation of personalized versions of the given GUI view going forward. This functionality is commonly referred to as reinforcement learning with human feedback (RLHF).

In these implementations, the generative AI model 402 may function to generate a “target user interaction” for a personalized version of a given GUI view that is generated, and the reward model 408 may be configured to generate the reward value for the personalized version of the given GUI view by evaluating the actual user interaction with the personalized version of the GUI relative to the target user interaction (e.g., by comparing the actual user interaction to the target user interaction and determining the reward value based on the difference between the actual user interaction and the target user interaction). In this respect, the reward value may quantify the desirability of personalized versions of GUI views based on whether the user interactions with such GUI views align with expected user interactions. However, the values that are input to the reward model 408 and/or the reward values that are output by the reward model 408 may take various other forms as well.

The manner in which the actual and target user interactions are represented may take any of various forms. For instance, the actual user interaction may be represented by user-interaction parameters such as a number of clicks (e.g., on input-control elements) that occurred during the user interaction, a clickstream pattern (e.g., the sequence of clicks performed by the given user and the corresponding elements on which the given user clicked for each click in the sequence) that occurred during the interaction, a set of one or more audio inputs received from the given user (e.g., via a microphone) during the interaction, a set of one or more gesture inputs received from the user (e.g., via wearable devices such as smart watches, virtual-reality headsets, etc.) during the interaction, an amount of time spent during the interaction, one or more types of functions executed during the interaction (e.g., scrolling, zooming in or out, searching for a search term, etc.), and/or one or more outcomes of the user interaction (e.g., a percentage of a task completed during the interaction, among other possibilities, while the target user interaction may comprise target values for these user-interaction parameters.

Further, the manner in which the generative AI model 402 utilizes the reward values to refine its generation of personalized GUI views may take any of various forms. As one possibility, the generative AI model 402 may comprise a policy that forms the basis for the model's decision-making regarding personalized versions of GUI views, and the generative AI model 402 may refine this policy based on the reward values using a technique such as proximal policy optimization (PPO) (among other possibilities). In this respect, the generative AI model 402 may be configured to refine its policy based on each individual reward value that is generated by the reward model 408, or may be configured to refine its policy based on batches of multiple rewards values that are generated by the reward model 408, among other possibilities.

The manner in which the AI model 402 utilizes the reward value to refine its generation of personalized GUI views may also take other forms.

Further yet, the reward model 408 may comprise any type of data science model that is configured to generate reward values for personalized versions of GUI views based on user interaction, examples of which may comprise any of various types of AI models that may be trained and/or fine-tuned using machine-learning techniques such as supervised, self-supervised, and/or unsupervised learning.

The AI model architecture 400 may take various other forms as well.

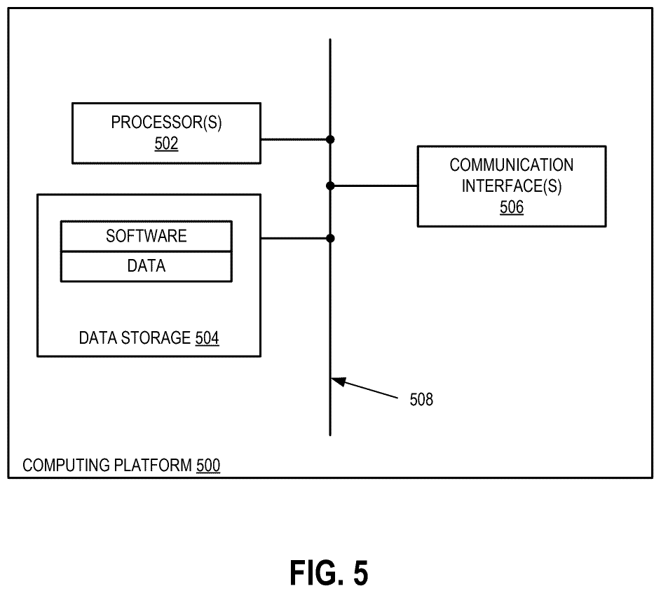

Turning now to FIG. 5, a simplified block diagram is provided to illustrate some structural components that may be included in an example computing platform 500 that may be configured to perform the platform-side functions disclosed herein. At a high level, the example computing platform 500 may generally comprise any one or more computer systems (e.g., one or more servers) that collectively include one or more processors 502, data storage 504, and one or more communication interfaces 506, each of which may be communicatively linked by a communication link 508 that may take the form of a system bus, a communication network such as a public, private, or hybrid cloud, or some other connection mechanism. Each of these components may take various forms.

For instance, the one or more processors 502 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 502 could comprise processing components that are distributed across a plurality of physical computing devices connected via a network, such as a computing cluster of a public, private, or hybrid cloud.

In turn, the data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, the data storage 504 may be capable of storing both (i) program instructions that are executable by the one or more processors 502 such that the example computing platform 500 is configured to perform any of the various functions disclosed herein (including but not limited to any of the server-side functions discussed above), and (ii) data that may be received, derived, or otherwise stored by the example computing platform 500.

The one or more communication interfaces 506 may comprise one or more interfaces that facilitate communication between the example computing platform 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB (Universal Serial Bus) 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 500 may additionally have an Input/Output (I/O) interface that includes or provides connectivity to I/O components that facilitate user interaction with the example computing platform 500, such as a keyboard, a mouse, a trackpad, a display screen, a touch-sensitive interface, a stylus, a virtual-reality headset, and/or one or more speaker components, among other possibilities.

It should be understood that the example computing platform 500 is one example of a computing platform that may be used with the examples described herein. Numerous other arrangements are possible and contemplated herein. For instance, in other examples, the example computing platform 500 may include additional components not pictured and/or more or less of the pictured components.

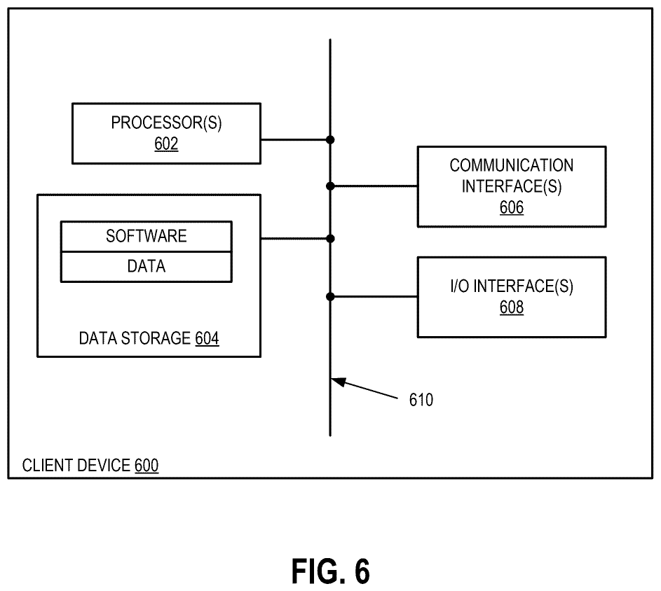

Turning next to FIG. 6, a simplified block diagram is provided to illustrate some structural components that may be included in an example client device 600 that may be configured to perform some the client-side functions disclosed herein. At a high level, the example client device 600 may include one or more processors 602, data storage 604, one or more communication interfaces 606, and an I/O interface 608, each of which may be communicatively linked by a communication link 610 that may take the form a system bus and/or some other connection mechanism. Each of these components may take various forms.

For instance, the one or more processors 602 of the example client device 600 may comprise one or more processor components, such as one or more CPUs, GPUs, ASICs, DSPs, and/or programmable logic devices such as FPGAs, among other possible types of processing components.

In turn, the data storage 604 of the example client device 600 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 6, the data storage 604 may be capable of storing both (i) program instructions that are executable by the one or more processors 602 of the example client device 600 such that the example client device 600 is configured to perform any of the various functions disclosed herein (including but not limited to any of the client-side functions discussed above), and (ii) data that may be received, derived, or otherwise stored by the example client device 600.

The one or more communication interfaces 606 may comprise one or more interfaces that facilitate communication between the example client device 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.) , a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 608 may generally take the form of (i) one or more input interfaces that are configured to receive and/or capture information at the example client device 600 and (ii) one or more output interfaces that are configured to output information from the example client device 600 (e.g., for presentation to a given user). In this respect, the one or more input interfaces of I/O interface may include or provide connectivity to input components such as a microphone, a camera, a keyboard, a mouse, a trackpad, a touchscreen, an accelerometer, a gyroscope, a location signal receiver (e.g., a cellular signal receiver, a Wi-Fi Positioning System (WPS) receiver, a Bluetooth receiver, a Radio Frequency Identification (RFID) receiver, an Ultra-Wideband (UWB) receiver, a magnetic field receiver, a satellite signal receiver such as a GPS, etc.), and/or a stylus, among other possibilities, and the one or more output interfaces of the I/O interface 608 may include or provide connectivity to output components such as a display screen and/or an audio speaker, among other possibilities.

It should be understood that the example client device 600 is one example of a client device that may be used with the examples described herein. Numerous other arrangements are possible and contemplated herein. For instance, in other examples, the example client device 600 may include additional components not pictured and/or more or fewer of the pictured components.

Examples of the disclosed innovations have been described above. Those skilled in the art will understand, however, that changes and modifications may be made to the examples described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one communication interface;
at least one processor;
at least one non-transitory computer-readable medium; and
program instructions stored on the at least one non-transitory computer-readable medium that, when executed by the at least one processor, cause the computing platform to:
receive, from a client device associated with a given user, a request to access a given Graphical User Interface (GUI) view of a construction management software application;
obtain a set of baseline GUI data for the given GUI view;
obtain a set of feature data for use in personalizing the given GUI view for the given user, wherein the set of feature data comprises values for at least two of (i) a user-level feature that provides information about the given user, (ii) a party-level feature that provides information about a party with which the given user is associated, (iii) a project-level feature that provides information about a construction project with which the given GUI view is associated, or (iv) a similar-user feature that provides information about one or more other users determined to be similar to the given user;
obtain a set of payload data including content to be made available to the given user via the given GUI view;
generate a personalized version of the given GUI view based on the set of baseline GUI data, the set of feature data, and the set of payload data; and
cause the personalized version of the given GUI view to be presented to the given user.

2. The computing platform of claim 1, wherein the set of baseline GUI data comprises at least one of:
data that indicates a purpose of the given GUI view;
data that indicates a type of content to be presented via the given GUI view;
data that indicates user actions that are to be supported by the given GUI view; or
data that indicates a baseline layout of the given GUI view.

3. The computing platform of claim 1, wherein the set of feature data comprises values for each of (i) one or more user-level features that provide information about the given user, (ii) one or more party-level features that provide information about the party with which the given user is associated, (iii) one or more project-level features that provides information about a construction project with which the given GUI view is associated, and (iv) one or more similar-user features that provide information about one or more other users determined to be similar to the given user.

4. The computing platform of claim 1, wherein the program instructions that, when executed by the at least one processor, cause the computing platform to generate the personalized version of the given GUI view based on the set of baseline GUI data, the set of feature data, and the set of payload data comprise program instructions that, when executed by the at least one processor, cause the computing platform to:
use the set of baseline GUI data, the set of feature data, and the set of payload data to produce an input dataset for an Artificial Intelligence (AI) model architecture; and
input the input dataset into the AI model architecture and thereby cause the AI model architecture to generate the personalized version of the given GUI view.

5. The computing platform of claim 4, wherein the AI model architecture comprises a generative AI model, and wherein the input dataset for the AI model architecture comprises a prompt for the generative AI model that includes a request to generate the personalized version of the given GUI view and context for the request.

6. The computing platform of claim 5, wherein the AI model architecture further comprises a reward model that is configured to output a reward value for the personalized version of the given GUI view based on user interaction with the personalized version of the given GUI view, and wherein the generative AI model is configured to refine a policy for generating personalized versions of GUI views based on the reward value.

7. The computing platform of claim 4, wherein the personalized version of the given GUI view is defined by a set of configuration data output by the AI model architecture in response to the inputting of the input dataset.

8. The computing platform of claim 1, wherein the program instructions that, when executed by the at least one processor, cause the computing platform to cause the personalized version of the given GUI view to be presented to the given user comprise program instructions that, when executed by the at least one processor, cause the computing platform to:
transmit a communication to the client device that instructs the client device to render the personalized version of the given GUI view.

9. The computing platform of claim 1, wherein the personalized version of the given GUI view comprises at least one of (i) a personalized set of GUI elements included within the given GUI view, (ii) a personalized set of content presented via the given GUI view, or (iii) a personalized layout of the given GUI view.

10. The computing platform of claim 1, wherein the program instructions that, when executed by the at least one processor, cause the computing platform to generate the personalized version of the given GUI view based on the set of baseline GUI data, the set of feature data, and the set of payload data comprise program instructions that, when executed by the at least one processor, cause the computing platform to:
extract one or more semantic meanings from textual content included in the payload data.

11. A non-transitory computer-readable medium, wherein the non-transitory computer-readable medium is provisioned with program instructions that, when executed by at least one processor, cause a computing platform to:
receive, from a client device associated with a given user, a request to access a given Graphical User Interface (GUI) view of a construction management software application;
obtain a set of baseline GUI data for the given GUI view;
obtain a set of feature data for use in personalizing the given GUI view for the given user, wherein the set of feature data comprises values for at least two of (i) a user-level feature that provides information about the given user, (ii) a party-level feature that provides information about a party with which the given user is associated, (iii) a project-level feature that provides information about a construction project with which the given GUI view is associated, or (iv) a similar-user feature that provides information about one or more other users determined to be similar to the given user;
obtain a set of payload data including content to be made available to the given user via the given GUI view;
generate a personalized version of the given GUI view based on the set of baseline GUI data, the set of feature data, and the set of payload data; and
cause the personalized version of the given GUI view to be presented to the given user.

12. The non-transitory computer-readable medium of claim 11, wherein the set of baseline GUI data comprises at least one of:
data that indicates a purpose of the given GUI view;
data that indicates a type of content to be presented via the given GUI view;
data that indicates user actions that are to be supported by the given GUI view; or
data that indicates a baseline layout of the given GUI view.

13. The non-transitory computer-readable medium of claim 11, wherein the set of feature data comprises values for each of (i) one or more user-level features that provide information about the given user, (ii) one or more party-level features that provide information about the party with which the given user is associated, (iii) one or more project-level features that provides information about a construction project with which the given GUI view is associated, and (iv) one or more similar-user features that provide information about one or more other users determined to be similar to the given user.

14. The non-transitory computer-readable medium of claim 11, wherein the program instructions that, when executed by the at least one processor, cause the computing platform to generate the personalized version of the given GUI view based on the set of baseline GUI data, the set of feature data, and the set of payload data comprise program instructions that, when executed by the at least one processor, cause the computing platform to:
use the set of baseline GUI data, the set of feature data, and the set of payload data to produce an input dataset for an Artificial Intelligence (AI) model architecture; and
input the input dataset into the AI model architecture and thereby cause the AI model architecture to generate the personalized version of the given GUI view.

15. The non-transitory computer-readable medium of claim 14, wherein the AI model architecture comprises a generative AI model, and wherein the input dataset for the AI model architecture comprises a prompt for the generative AI model that includes a request to generate the personalized version of the given GUI view and context for the request.

16. The non-transitory computer-readable medium of claim 15, wherein the AI model architecture further comprises a reward model that is configured to output a reward value for the personalized version of the given GUI view based on user interaction with the personalized version of the given GUI view, and wherein the generative AI model is configured to refine a policy for generating personalized versions of GUI views based on the reward value.

17. The non-transitory computer-readable medium of claim 14, wherein the personalized version of the given GUI view is defined by a set of configuration data output by the AI model architecture in response to the inputting of the input dataset.

18. The non-transitory computer-readable medium of claim 11, wherein the program instructions that, when executed by the at least one processor, cause the computing platform to cause the personalized version of the given GUI view to be presented to the given user comprise program instructions that, when executed by the at least one processor, cause the computing platform to:
transmit a communication to the client device that instructs the client device to render the personalized version of the given GUI view.

19. The non-transitory computer-readable medium platform of claim 11, wherein the personalized version of the given GUI view comprises at least one of (i) a personalized set of GUI elements included within the given GUI view, (ii) a personalized set of content presented via the given GUI view, or (iii) a personalized layout of the given GUI view.

20. A method comprising:
receiving, from a client device associated with a given user, a request to access a given Graphical User Interface (GUI) view of a construction management software application;
obtaining a set of baseline GUI data for the given GUI view;
obtaining a set of feature data for use in personalizing the given GUI view for the given user, wherein the set of feature data comprises values for at least two of (i) a user-level feature that provides information about the given user, (ii) a party-level feature that provides information about a party with which the given user is associated, (iii) a project-level feature that provides information about a construction project with which the given GUI view is associated, or (iv) a similar-user feature that provides information about one or more other users determined to be similar to the given user;
obtaining a set of payload data including content to be made available to the given user via the given GUI view;
generating a personalized version of the given GUI view based on the set of baseline GUI data, the set of feature data, and the set of payload data; and
causing the personalized version of the given GUI view to be presented to the given user.
